(19) United States
(12) Patent Application Publication
(10) Pub. No.: US 2025/0306305 A1
(43) Pub. Date: Oct. 2, 2025

(54) OPTICAL FIBER ASSEMBLY, OPTICAL FIBER HOLDER STRUCTURE, OPTICAL COMMUNICATION DEVICE, AND MANUFACTURING METHOD OF OPTICAL COMMUNICATION DEVICE

(71) Applicant: Wistron Corporation, New Taipei City (TW)

(72) Inventors: Chun Yang Chang, New Taipei City (TW); Guan Fu Lu, New Taipei City (TW)

(73) Assignee: Wistron Corporation, New Taipei City (TW)

(21) Appl. No.: 18/733,865

(22) Filed: Jun. 5, 2024

(30) Foreign Application Priority Data
Apr. 2, 2024 (TW) 113112513

(51) Int. Cl. G02B 6/42

(52) U.S. Cl. CPC G02B 6/4239; G02B 6/4243

(57) ABSTRACT

An optical communication device includes a housing and an optical engine and at least one optical fiber assembly configured in the housing. The optical engine has a photonic integrated circuit (PIC). The optical fiber assembly includes a base having a groove, a lid assembled to the base and having an adhesive surface, an optical fiber, and a first adhesive. Part of the optical fiber is accommodated along the groove, and positioned in the groove by abutting against the lid. The adhesive surface is fixed to the PIC via the first adhesive such that the optical fiber is optically coupled to an optical waveguide of the PIC. An optical fiber holder structure, an optical communication device, and a manufacturing method thereof are also provided.

### CROSS-REFERENCE TO RELATED APPLICATION

This application claims the priority benefit of Taiwan application serial no. 113112513, filed on Apr. 2, 2024. The entirety of the above-mentioned patent application is hereby incorporated by reference herein and made a part of this specification.

### BACKGROUND

### Technical Field

The disclosure relates to an optical fiber assembly, an optical fiber holder structure, an optical communication device, and a manufacturing method of the optical communication device.

### Description of Related Art

With the transmission requirements of high-performance computing and artificial intelligence (AI) applications, as well as the need to accelerate the performance of data centers and cloud computing, traditional telecommunications transmission has faced bottlenecks, and optical signal transmission has become a new generation solution, and thus silicon photonics technology and related packaging optical components have become the focus of attention. For example, AI servers will use a large number of 800G optical fiber modules and higher transmission speed optical fiber module products. It is expected that 51.2T high-speed transmission silicon photonic chips and related technologies for co-packaged optical component will be widely adopted starting in the coming year.

However, in the current product process, the existing technology cannot meet the specification requirements of miniaturized high-speed modules in terms of manufacturing process. Instead, current optical modules are used, but it cannot successfully solve the risk of mechanical interference and meet the size required by the specification.

### SUMMARY

The disclosure provides an optical fiber assembly, an optical fiber holder structure, an optical communication device, and a manufacturing method of the optical communication device to effectively achieve the required spatial configuration and take into account both structural strength and optical characteristics.

An optical fiber assembly of the disclosure includes a base having a groove, a lid assembled to the base and having an adhesive surface, an optical fiber, and a first adhesive. Part of the optical fiber is accommodated along the groove, and positioned in the groove by abutting against the lid. The adhesive surface is fixed to a photonic integrated circuit (PIC) of an optical engine via the first adhesive such that the optical fiber is optically coupled to an optical waveguide of the photonic integrated circuit.

An optical fiber holder structure of the disclosure is configured to connect an optical fiber to a photonic integrated circuit of an optical engine. The optical fiber holder structure includes a base and a lid. The base is in a stepped shape and has high and low steps. The base also has a groove at the high step, a first front edge, and a first rear edge. The groove is connected between the first front edge and the first rear edge. The first front edge faces the photonic integrated circuit, the first rear edge faces away from the photonic integrated circuit, and the first rear edge is inclined to connect the high step and the low step. The lid is assembled to the high step of the base, so that part of the optical fiber is accommodated along the groove, and positioned in the groove by abutting against the lid. The lid has a second front edge and a second rear edge.

The second front edge faces the photonic integrated circuit and protrudes from the first front edge.

The second rear edge is aligned with the first rear edge at the high step, and a length of the base along an extending direction of the optical fiber is greater than a length of the lid along an extending direction of the optical fiber.

An optical communication device of the disclosure includes a housing and an optical engine and at least one optical fiber assembly configured in the housing. The optical engine has a photonic integrated circuit. The optical fiber assembly includes a base having a groove, a lid assembled to the base and having an adhesive surface, an optical fiber, and a first adhesive. Part of the optical fiber is accommodated along the groove and positioned in the groove by abutting against the lid. The adhesive surface is fixed to the photonic integrated circuit via the first adhesive such that the optical fiber is optically coupled to an optical waveguide of the photonic integrated circuit.

A manufacturing method of an optical communication device of the disclosure includes the following steps. An optical module, an optical fiber assembly, and a housing are provided. The optical module includes an optical engine and a circuit board. The optical engine is configured on the circuit board. The optical fiber assembly includes a base, a lid, an optical fiber, and a stopper. The optical fiber passes through the stopper. The optical fiber is clamped between the base and the lid, so that an end of the optical fiber protrudes out of the base and the lid. The housing includes a bottom housing and a top housing. The circuit board and the optical fiber assembly are assembled to the bottom housing respectively. The optical fiber assembly is limited by the stopper inserted into a recess of the bottom housing. The optical fiber assembly is optically coupled to a photonic integrated circuit. The top housing is assembled to the bottom housing to cover the optical engine and optical fiber assembly, so that the optical fiber and the stopper are fixed between the top housing and the bottom housing. The step of optically coupling the optical fiber assembly to the photonic integrated circuit also includes the following. The optical module and the bottom housing are placed on an optical coupling machine. A first adhesive is provided on an adhesive surface of the lid, so that the adhesive surface abuts against the photonic integrated circuit via the first adhesive. The optical engine is started. An end of the optical fiber is optically coupled to an optical waveguide of the photonic integrated circuit via the optical coupling machine. The first adhesive is cured.

Based on the above, for the optical fiber assembly, the optical fiber holder structure, and the optical communication device in this case, the relevant structures thereof are distributed on different components. The base has the groove for accommodating the optical fiber, and the lid has an adhesive surface for adhering and fixing to the photonic integrated circuit. Therefore, the required functions of fixing the optical fiber and optically coupling to the photonic integrated circuit are added to the base and the lid respectively. In this way, a single component only needs to correspond to a single additional function, so that the components (base and lid) can have adjustable space according to size requirements and optical coupling process requirements, and the completed optical fiber holder structure can increase the gap between the optical fiber holder structure and the housing.

According to the component made above, the area clamped during the optical coupling process can be increased. At the same time, the bonding strength between components after using adhesive can also be changed accordingly particularly for the assembled optical communication device, i.e., the adhesive configuration between the optical fiber assembly and the optical engine as well as the structural relationship between the optical fiber assembly and the housing.

### BRIEF DESCRIPTION OF THE DRAWINGS

FIG. 1 is a schematic view of an optical communication device according to an embodiment of the disclosure.

FIG. 2 is an exploded view of some components of the optical communication device of

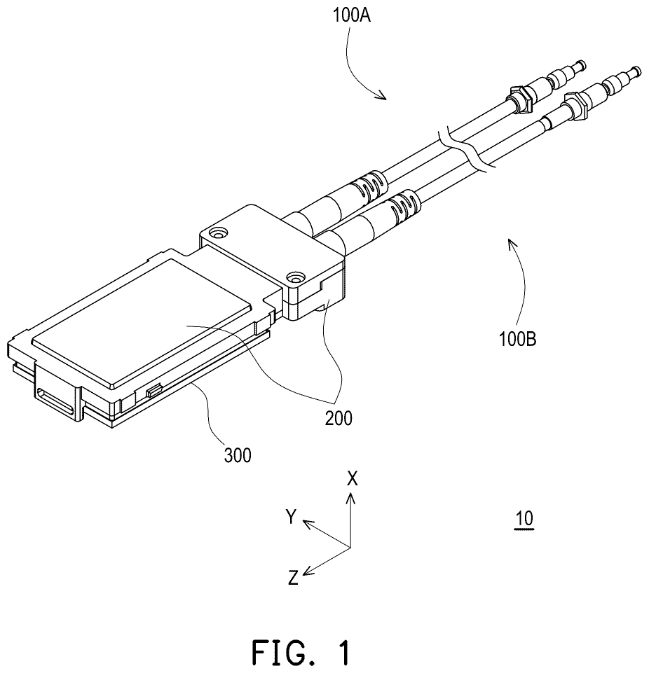

FIG. 1.

FIG. 3 is an exploded view of some components of the optical communication device of FIG. 1.

FIG. 4A is an exploded view of some components of an optical fiber assembly.

FIG. 4B is a partial cross-sectional view of an optical communication device.

FIG. 5 is a flowchart of a manufacturing method of an optical communication device.

FIG. 6A to FIG. 6C are partial component schematic views of an optical communication device according to different embodiments of the disclosure.

### DESCRIPTION OF THE EMBODIMENTS

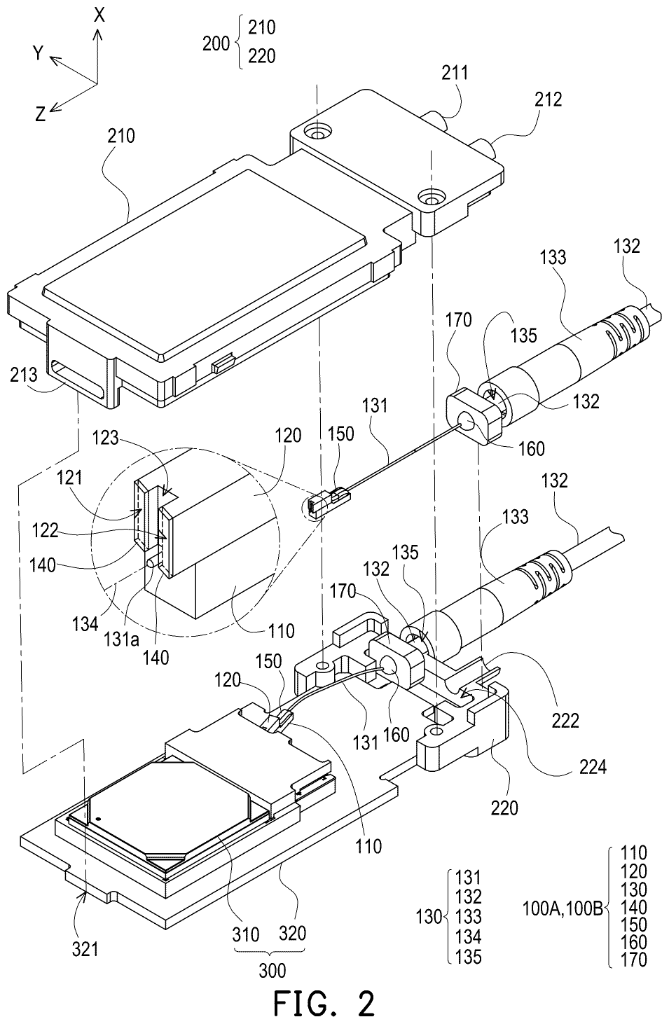

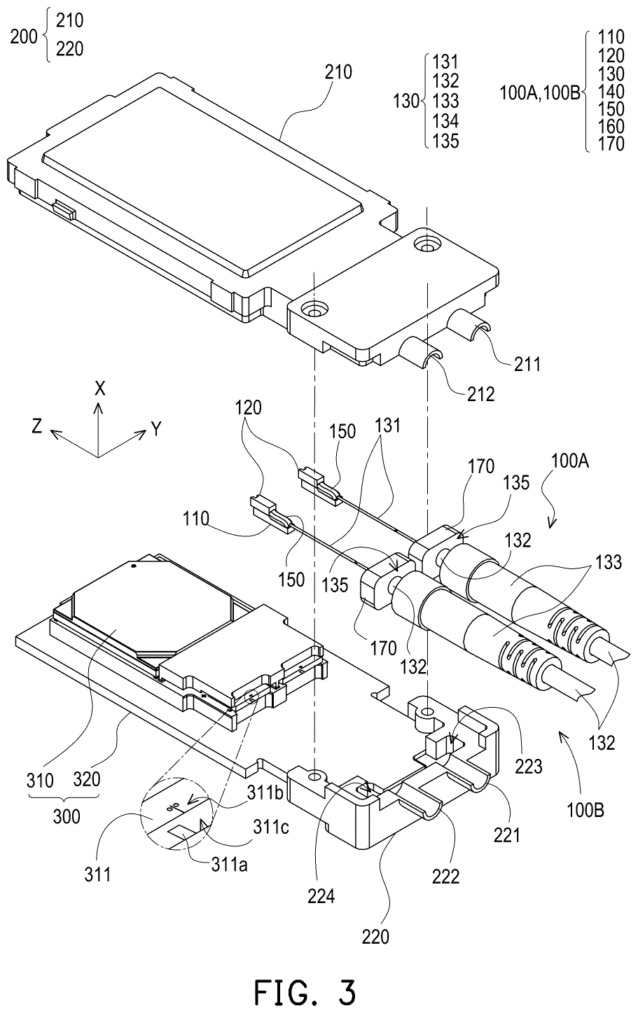

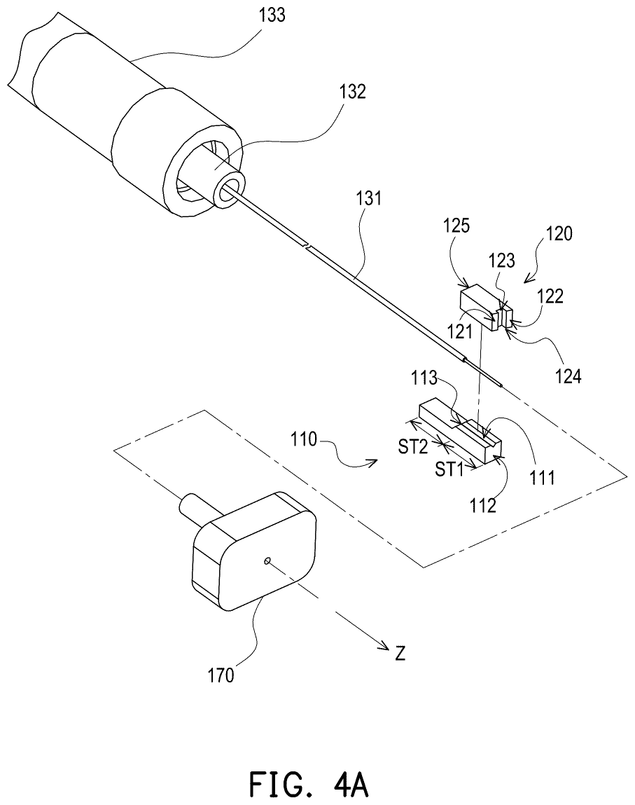

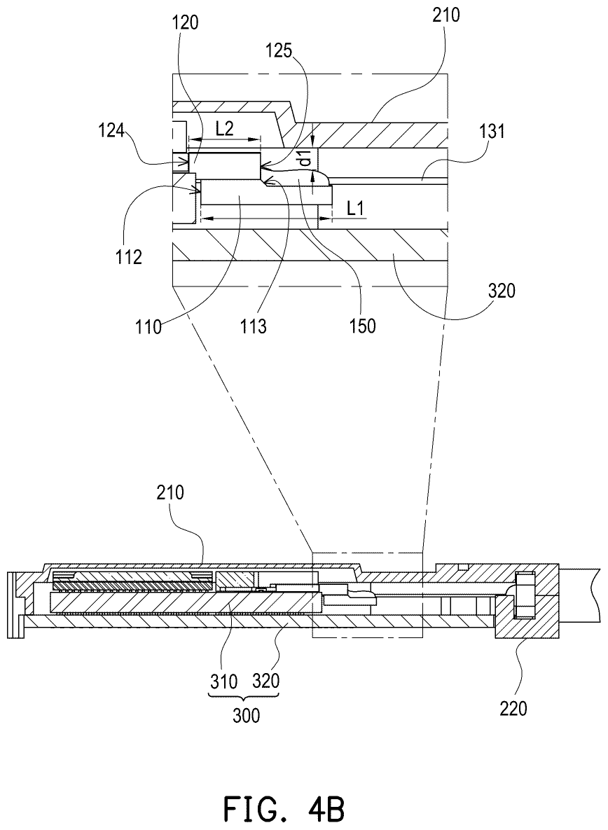

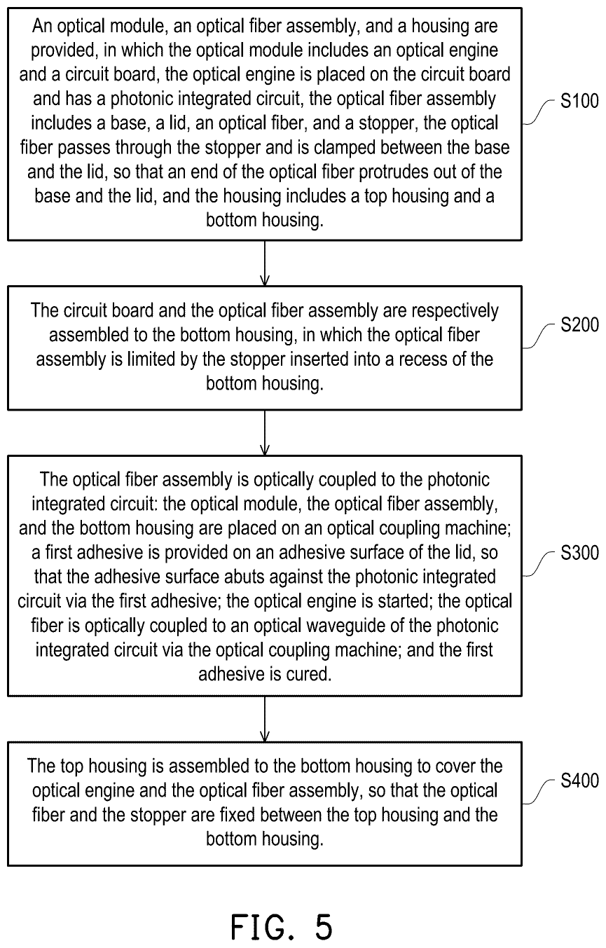

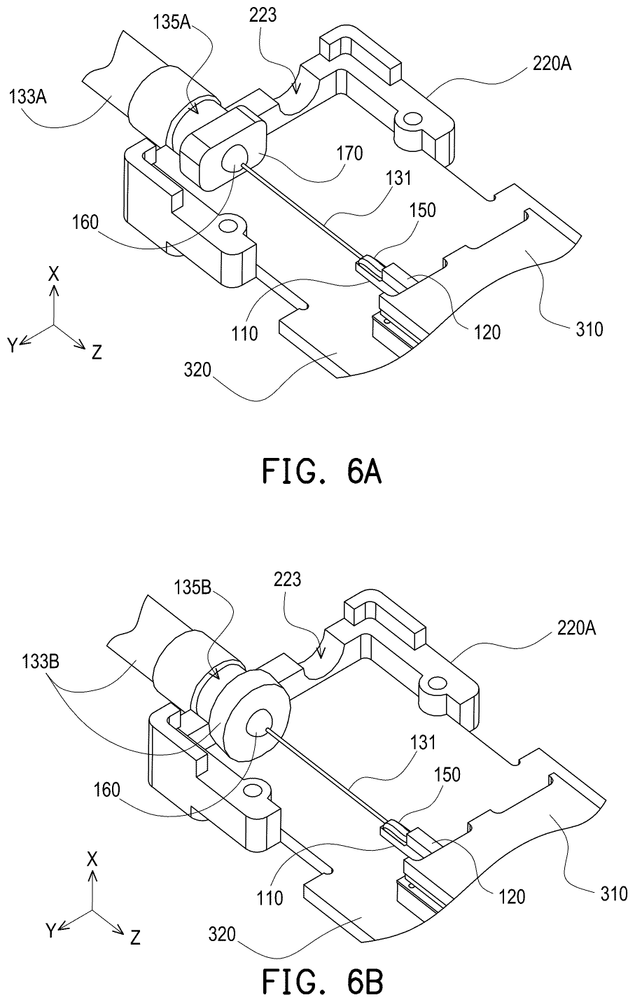

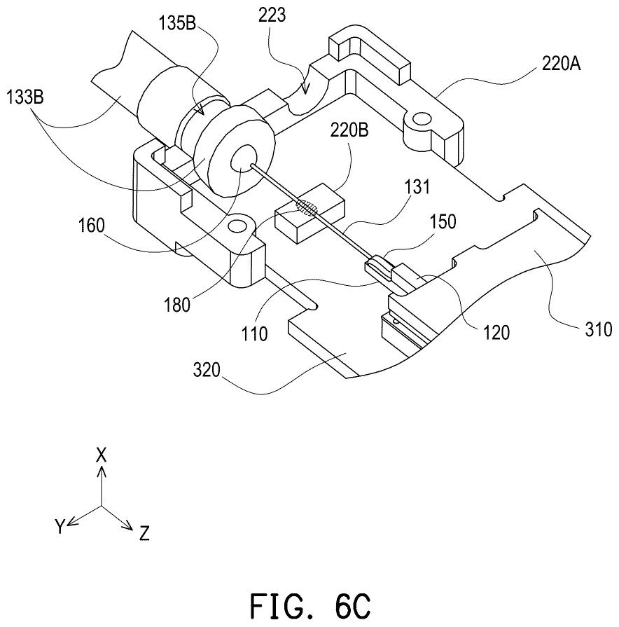

FIG. 1 is a schematic diagram of an optical communication device according to an embodiment of the disclosure. FIG. 2 is an exploded view of some components of the optical communication device of FIG. 1. FIG. 3 is an exploded view of some components of the optical communication device of FIG. 1. FIG. 3 adopts a different perspective and a different degree of decomposition (explosion) than those of FIG. 2 to facilitate simultaneous comparison of FIG. 2 and FIG. 3. At the same time, rectangular coordinates XYZ are provided to facilitate component description. Referring to FIG. 1 to FIG. 3 at the same time, in the embodiment, an optical communication device 10 includes a housing 200 and an optical module 300 and at least one optical fiber assembly (here, two optical fiber assemblies 100A and 100B are taken as examples, but are not limited to thereto) configured in the housing 200.

As shown in FIG. 2 and FIG. 3, the optical module 300 includes an optical engine 310 and a circuit board 320. The optical engine 310 is configured on the circuit board 320, and the optical engine 310 has a photonic integrated circuit 311 for optical communication with the optical fiber assemblies 100A and 100B. FIG. 4A is an exploded view of some components of an optical fiber assembly. Referring to FIG. 2 to FIG. 4A at the same time, the optical fiber assemblies 100A and 100B of the embodiment have the same components, each including a base 110, a lid 120, an optical fiber 130, and a first adhesive 140. The base 110 has a groove 111. The lid 120 is assembled to the base 110. The lid 120 has an adhesive surface 121. Part of the optical fiber 130 is accommodated along the groove 111 and positioned in the groove 111 by abutting against the lid 120. The adhesive surface 121 is then fixed to the photonic integrated circuit 311 via the first adhesive 140 such that the optical fiber 130 is optically coupled to an optical waveguide 311a of the photonic integrated circuit 311.

Roughly speaking, as shown in FIG. 2 and FIG. 3, the housing 200 includes a top housing 210 and a bottom housing 220 that can be assembled with each other, and the optical engine 310 is assembled to the bottom housing 220 along with the circuit board 320, and then after the optical fiber assemblies 100A and 100B are assembled to the bottom housing 220 and optically coupled to the optical engine 310, the top housing 210 can be assembled to the bottom housing 220 to cover the optical module 300 and the optical fiber assemblies 100A and 100B, thereby completing the assembly process of the optical communication device 10.

In detail, the adhesive surfaces 121 and 122 are inclined relative to an optical axis 134 of the optical fiber 130 (the optical axis 134 is parallel to the Z-axis or consistent with the Z-axis), and the inclination angle is adapted for an optical coupling angle of the optical fiber 130 and the optical waveguide 311a. For example, in order to ensure that light is transmitted without leakage between the optical fiber 130 and the optical waveguide 311a of different media, it is necessary to provide specific incident angle characteristics for the refraction of light. Therefore, the lid 120 of the embodiment has the inclination feature of the adhesive surfaces 121 and 122 at a specific angle to meet the transmission requirements of light. Simply put, the optical fiber assemblies 100A and 100B of the embodiment use the adhesive surfaces 121 and 122 of the lid 120 to connect with a side surface 311c of the photonic integrated circuit 311 of the optical engine 310 via the first adhesive 140, so that a wire core 131 of the optical fiber 130, especially an end 131a protruding from the adhesive surfaces 121 and 122 (as shown in FIG. 2) can correspond to the optical waveguide 311a of the photonic integrated circuit 311 to achieve an optical coupling effect that enables light to be transmitted smoothly between the two. At the same time, during the optical coupling process, after completing the adhering and fixing via the adhesive surfaces 121 and 122, the inclination feature allows the optical fiber 130 to meet the refraction requirements of light.

FIG. 4B is a partial cross-sectional view of an optical communication device. Referring to FIG. 4A and FIG. 4B at the same time and comparing with FIG. 2 or FIG. 3, in the embodiment, the optical fiber 130, the base 110, and the lid 120 form an optical fiber holder structure to facilitate the docking of the optical fiber 130 to the photonic integrated circuit 311 of the optical engine 310. Here, the base 110 is in a stepped shape and has a high step ST1 and a low step ST2. The base 110 also has a first front edge 112 and a first rear edge 113 located at the high step ST1 and opposite to each other. The first front edge 112 faces the photonic integrated circuit 311. The first rear edge 113 faces away from the photonic integrated circuit 311. The groove 111 is located at the high step ST11 and connected between the first front edge 112 and the first rear edge 113. The first rear edge 113 is inclined to connect the high step ST1 and the low step ST2.

The lid 120 is assembled to the high step ST1 of the base 110, so that part of the optical fiber 130 is accommodated along the groove 111 and positioned in the groove 111 by abutting against the lid 120. The lid 120 has a second front edge 124 and a second rear edge 125 opposite to each other. The second front edge 124 faces the photonic integrated circuit 311 and protrudes from the first front edge 112. The second rear edge 125 is aligned with the first rear edge 113 at the high step ST1, and a length L1 of the base 110 along an extending direction of the optical fiber 130 is greater than a length L2 of the lid 120 along an extending direction of the optical fiber 130. The adhesive surfaces 121 and 122 are located at the second front edge 124.

A second adhesive 150 is configured on an upper surface of the low step ST2 of the base 110 to adhere and fix the optical fiber 130, the first rear edge 113 at the low step ST2 and the high step ST1 of the base 110, and the second rear edge 125 of the lid 120 together so as to complete the optical fiber holder structure. The completed optical fiber holder structure has a relative distance d1 compared to the housing 200. Here, the second adhesive 150 is relative to the top housing 210 of the housing 200 to ensure that there is no structural interference between the optical fiber holder structure and the housing 200.

FIG. 5 is a flowchart of a manufacturing method of an optical communication device. Referring to FIG. 5 and correspondingly referring to at least any one of FIG. 2 to FIG. 4A according to the steps. First, as shown in step S100, the optical module 300, the optical fiber assemblies 100A and 100B, and the housing 200 are provided, in which the structural features of each component are as mentioned above. Next, as shown in step S200, the circuit board 320 and the optical fiber assemblies 100A and 100B are respectively assembled to the bottom housing 220. Next, as shown in step S300, the optical fiber assemblies 100A and 100B are optically coupled to the photonic integrated circuit 311, and finally, as shown in step S400, the top housing 210 is assembled to the bottom housing 220 to cover the optical engine 310 and the optical fiber assemblies 100A and 100B, so that the optical fiber assemblies 100A and 100B are fixed between the top housing 210 and the bottom housing 220.

The following will be described in detail based on the manufacturing sequence of semi-finished products/finished products and the above steps.

The first is the manufacturing process of the optical fiber assemblies 100A and 100B. Referring to FIG. 4A and comparing with FIG. 2, the lid 120 of the embodiment also has a recess 123, which separates the adhesive surfaces 121 and 122 into two parts. After extending out of the groove 111 with a V-shaped cross section, an end of the optical fiber 130 (the end 131a shown in FIG. 2) will be located at a position corresponding to the recess 123 and between the two parts (adhesive surfaces 121 and 122). Therefore, when assembling the lid 120 and the base 110 together, it is also necessary to ensure that the adhesive surfaces 121 and 122 protrude outside the base 110 to avoid interference between the wire core 131 and the photonic integrated circuit 311, and since the recess 123 can expose the end 131a of the optical fiber 130, it is beneficial to aligning with the position of the optical waveguide 311a.

In addition to the aforementioned components, the optical fiber assemblies 100A and 100B of the embodiment also include a stopper 170, a second adhesive 150, and a third adhesive 160. The optical fiber 130 is further divided into an outer covering layer 132, a protective sleeve 133, and the aforementioned wire core 131. The outer covering layer 132 covers the wire core 131. The protective sleeve 133 covers the outer covering layer 132. Accordingly, the manufacturing method of the optical fiber assemblies 100A and 100B actually needs to include: passing the optical fiber 130 through the stopper 170, and adhering and fixing the wire core 131 of the optical fiber 130 and the stopper 170 together via the third adhesive 160 (as shown in FIG. 2). Next, part of the optical fiber 130 is placed along the groove 111 of the base 110 so that the end 131a of the optical fiber 130 protrudes out of the groove 111. Next, the lid 120 and the base 110 are assembled together, so that part of the optical fiber 130 in the groove 111 is clamped between the lid 120 and the base 110. Finally, the lid 120, the optical fiber 130, and the base 110 are adhered and fixed together via the second adhesive 150. The completed optical fiber assemblies 100A and 100B are as shown in FIG. 2 and FIG. 3.

After the assembly of the optical fiber assemblies 100A and 100B is completed, step S200 is performed. The stoppers 170 are respectively inserted into the recesses 223 and 224 of the bottom housing 220 along the X-axis to be pre-positioned and supported, as shown in FIG. 2 or FIG. 3, so that the stopper 170 can produce a limiting effect on both the Z-axis and the Y-axis relative to the bottom housing 220. It should also be mentioned that a mark 311b is disposed on a top surface of the photonic integrated circuit 311, so that when performing the optical coupling process, the operator can determine the position of the optical waveguide 311a below based on the location of the mark 311b. Therefore, when performing step S200, with the end 131a of the optical fiber 130 exposed by the recess 123 of the lid 120, the operator can align the lid 120 and the base 110 to the mark 311b as a preliminary alignment position.

Furthermore, due to the presence of the stopper 170, the optical fiber 130 will form a neck portion 135 between the stopper 170 and the protective sleeve 133, and part of the outer covering layer 132 of the optical fiber 130 will be exposed from the neck portion 135. Therefore, when the stopper 170 is inserted into the recesses 223 and 234, it also means that the neck portion 135 will be partially limited by the bottom housing 220 by being supported on and locked onto the bottom housing 220. Here, the bottom housing 220 can be regarded as the support and carrying structure of the optical fiber assemblies 100A and 100B, and is also convenient for subsequent optical coupling processes.

Next, the optical coupling process shown in step S300 is performed, which includes: placing the optical module 300 and the bottom housing 220 on an optical coupling machine (not shown), and applying the first adhesive 140 to the adhesive surfaces 121 and 122 of the lid 120, so that the adhesive surfaces 121 and 122 abut against the photonic integrated circuit 311 via the first adhesive 140. Then, the optical engine 310 is started, and the end 131a of the optical fiber 130 is optically coupled to the optical waveguide 311a of the photonic integrated circuit 311 via the optical coupling machine. Here, the optical coupling machine can clamp two opposite sides of the lid 120 and the base 110 via a movable clamp (not shown), thereby adjusting a coupling position of the optical fiber 130 corresponding to the optical waveguide 311a, and determining whether the relative position of the optical fiber 130 and the optical waveguide 311a meets the optical coupling conditions by light characteristics sensed by a sensor (not shown). After the alignment (optical coupling) is completed, the first adhesive 140 can be cured to ensure that the optical fiber 130 and the optical waveguide 311a are in the correct corresponding position.

It should be mentioned here that in order to ensure the optical coupling effect, the embodiment provides a dual curing process for the first adhesive 140. That is, after the aforementioned optical coupling process is completed, pre-curing is first performed on the first adhesive 140, that is, temporarily curing the first adhesive 140 by ultraviolet light, and then post-curing is performed on the completed module, that is, heating and curing the first adhesive 140 to ensure the structural strength of the cured first adhesive 140 and avoid environmental moisture or temperature from affecting it. Here, the optical coupling variation between the optical fiber 130 and the optical waveguide 311a in the embodiment due to the aforementioned adhering and curing processes is approximately +15%.

Finally, when step S400 is performed, as shown in FIG. 2 and FIG. 3, the top housing 210 is assembled to the bottom housing 220 to cover the aforementioned optical engine 310 and optical fiber assemblies 100A and 100B that have completed the optical coupling, so that the optical fiber 130 and the stopper 170 are fixed between the top housing 210 and the bottom housing 220. At the same time, the bottom housing 220 also has clamping parts 221 and 222, and the top housing 210 also has corresponding clamping parts 211 and 212. Therefore, during the process of assembling the top housing 210 and the bottom housing 220 together, the clamping parts 222 and 212 correspond to each other, and the clamping parts 211 and 221 correspond to each other, so as to respectively extend into the protective sleeve 133 to clamp the outer covering layer 132 of the optical fiber 130 to complete the clamping of the optical fiber 130. At the same time, the assembled top housing 210 and bottom housing 220 can also provide a pressing effect on the stopper 170, so that the stopper 170 is fixed in the housing 200 along the X-axis. In addition, as shown in FIG. 2, the top housing 210 also has a buckle 213 for engaging with a side edge protrusion part 321 of the circuit board 320 so as to improve the structural strength and stability between the housing 200 and the optical module 300. Accordingly, when subsequent tensile and bending tests are conducted to verify the optical coupling of the optical engine 310 and the optical fiber assemblies 100A and 100B, the optical coupling variation caused by it was approximately ±20%, thus proving the structural strength and stability between the housing 200 and the optical module 300.

FIG. 6A to FIG. 6C are partial component schematic views of an optical communication device according to different embodiments of the disclosure. Referring to FIG. 6A first, and comparing with FIG. 2 or FIG. 3, different from the previous embodiment where there is a gap between the protective sleeve 133 and the stopper 170, a neck portion 135A of the embodiment is part of a protective sleeve 133A and formed as an annular recess to be supported on and locked onto the arc-shaped groove 223 of a bottom housing 220A. Similarly, the top housing (not shown) of the embodiment also has a corresponding arc-shaped groove like the bottom housing 220A to connect with the annular recess of the protective sleeve 133A.

Referring to FIG. 6B, the embodiment further extends a protective sleeve 133B into the bottom housing 220A and forms a neck portion 135B, so that the stopper 170 and the annular recess (neck portions 135 and 135A) of the previous embodiment can be regarded as part of the protective sleeve 133B.

Referring to FIG. 6C, which further provides a support member 220B on the basis of FIG. 6B. As shown in FIG. 6C, the wire core 131 of the optical fiber 130 is suspended on the circuit board 320 between the stopper formed by the protective sleeve 133B and the base 110, the lid 120, and the second adhesive 150. Accordingly, the support member 220B is disposed on the circuit board 320 to support the suspended wire core 131. At the same time, the embodiment further provides a fourth adhesive 180 to adhere and fix the suspended portion of the wire core 131 and the support member 220B together so as to increase the structural strength of the optical fiber 130 at the suspended portion.

To sum up, in the above-mentioned embodiments of the disclosure, the relevant structures of the optical fiber assembly and the optical communication device are distributed on different components. The base has the groove for accommodating the optical fiber, and the lid has the adhesive surface for adhering and fixing to the photonic integrated circuit. Therefore, the required functions of fixing the optical fiber and optically coupling to the photonic integrated circuit are added to the base and the lid respectively. In this way, the complexity of component production will be effectively simplified. A single component only needs to correspond to a single additional function, so that the components (base and lid) can have adjustable space according to size requirements and optical coupling process requirements.

More importantly, the optical fiber assembly further includes the stopper, so that after the optical fiber passes through the stopper, the end of the optical fiber is clamped by the base and the lid. In this way, during the process of optical coupling and assembly of the optical fiber assembly with the housing and optical module, the stopper is inserted into the recess of the housing to achieve a pre-positioning effect, effectively improving the structural stability of subsequent optical coupling, and at the same time, providing a support effect for the optical fiber, so as to help the optical coupling process proceed smoothly. In addition, after the optical coupling is completed, the optical module and optical fiber assembly can also be clamped and fixed between the top housing and the bottom housing through the stopper and the optical fiber. Therefore, the structural limitations caused by the stopper and the housing allow the optical fiber assembly to withstand external force from outside the housing, so that the force is blocked due to the aforementioned structural limitations and prevented from being transmitted into the housing and affecting the docking relationship between the optical fiber assembly and the optical engine.

What is claimed is:

1. An optical fiber assembly, comprising:
a base, having a groove;
a lid, assembled to the base, and having an adhesive surface;
an optical fiber, wherein part of the optical fiber is accommodated along the groove, and positioned in the groove by abutting against the lid; and
a first adhesive, wherein the adhesive surface is fixed to a photonic integrated circuit (PIC) of an optical engine via the first adhesive, so that the optical fiber is optically coupled to an optical waveguide of the photonic integrated circuit.

2. The optical fiber assembly according to claim 1, wherein the adhesive surface is inclined relative to an optical axis of the optical fiber, and an inclination angle is adapted for an optical coupling angle between the optical fiber and the optical waveguide.

3. The optical fiber assembly according to claim 1, further comprising a second adhesive to fix the optical fiber, the base, and the lid together.

4. The optical fiber assembly according to claim 1, wherein the adhesive surface protrudes outside the base.

5. The optical fiber assembly according to claim 1, wherein the lid also has a recess that separates the adhesive surface into two parts, and after extending out of the groove, an end of the optical fiber is located at a position corresponding to the recess and between the two parts.

6. The optical fiber assembly according to claim 1, further comprising a stopper and a third adhesive, a wire core of the optical fiber passes through the stopper, the third adhesive fixes the wire core and the stopper together, the optical fiber has a protective sleeve, the optical fiber has a neck portion between the protective sleeve and the stopper, during an optical coupling process, the optical engine is placed on a carrying structure, the optical fiber assembly is locked onto the carrying structure via the stopper, the protective sleeve, and the neck portion, and the stopper and the carrying structure generate an interference along an optical axis of the optical fiber.

7. The optical fiber assembly according to claim 6, wherein the optical fiber comprises the wire core, an outer covering layer, and the protective sleeve, the outer covering layer covers the wire core, the protective sleeve covers the outer covering layer, part of the outer covering layer exposes the optical fiber from the neck portion, the neck portion is an annular recess of the protective sleeve, and the stopper is part of the protective sleeve.

8. The optical fiber assembly according to claim 6, wherein the optical fiber comprises the wire core, an outer covering layer, and the protective sleeve, the outer covering layer covers the wire core, the protective sleeve covers the outer covering layer, and part of the wire core located between the stopper and the base is supported and fixed on a support member.

9. An optical fiber holder structure for connecting an optical fiber to a photonic integrated circuit of an optical engine, the optical fiber holder structure comprising:
a base, having a stepped shape, and having a high step, a groove located on the high step, a first front edge, and a first rear edge, wherein the groove is connected between the first front edge and the first rear edge, the first front edge faces the photonic integrated circuit, the first rear edge faces away from the photonic integrated circuit, and the first rear edge is inclined to connect the high step; and
a lid, assembled to the high step of the base, so that part of the optical fiber is accommodated along the groove, and positioned in the groove by abutting against the lid, wherein the lid has a second front edge and a second rear edge, the second front edge faces the photonic integrated circuit and protrudes from the first front edge, and the second rear edge is aligned with the first rear edge located at the high step.

10. The optical fiber holder structure according to claim 9, wherein the lid has an adhesive surface located at the first front edge, and the adhesive surface is fixed to the photonic integrated circuit via a first adhesive.

11. The optical fiber holder structure according to claim 10, wherein the adhesive surface is inclined relative to an optical axis of the optical fiber, and an inclination angle is adapted for an optical coupling angle of the optical fiber and an optical waveguide.

12. The optical fiber holder structure according to claim 10, wherein the lid also has a recess that separates the adhesive surface into two parts, and after extending out of the groove, an end of the optical fiber is located at a position corresponding to the recess and between the two parts.

13. The optical fiber holder structure according to claim 9, wherein the base also has a low step connected to the second rear edge.

14. The optical fiber holder structure according to claim 13, further comprising a second adhesive to fix the optical fiber, the first rear edge at the low step and the high step of the base, and the second rear edge of the lid together.

15. The optical fiber holder structure according to claim 9, wherein a length of the base along an extending direction of the optical fiber is greater than a length of the lid along an extending direction of the optical fiber.

16. An optical communication device, comprising:
a housing;
an optical engine, configured in the housing, and having a photonic integrated circuit;
at least one optical fiber assembly, configured in the housing, wherein the optical fiber assembly comprises:
a base, having a groove;
a lid, assembled to the base, and having an adhesive surface;
an optical fiber, wherein part of the optical fiber is accommodated along the groove and positioned in the groove by abutting against the lid; and
a first adhesive, wherein the adhesive surface is fixed to the photonic integrated circuit via the first adhesive, so that the optical fiber is optically coupled to an optical waveguide of the photonic integrated circuit.

17. The optical communication device according to claim 16, wherein the adhesive surface is inclined relative to an optical axis of the optical fiber, and an inclination angle is adapted for an optical coupling angle of the optical fiber and the optical waveguide.

18. The optical communication device according to claim 16, further comprising a second adhesive to fix the optical fiber, the base, and the lid together.

19. The optical communication device according to claim 16, wherein the adhesive surface protrudes outside the base.

20. The optical communication device according to claim 16, wherein the lid also has a recess that separates the adhesive surface into two parts, and after extending out of the groove, an end of the optical fiber is located at a position corresponding to the recess and between the two parts.

21. The optical communication device according to claim 16, wherein the optical fiber assembly further comprises a stopper and a third adhesive, the housing comprises a top housing and a bottom housing, the optical fiber passes through the stopper, the third adhesive fixes the optical fiber and the stopper together, the optical fiber has a protective sleeve, the optical fiber has a neck portion between the protective sleeve and the stopper, the stopper is limited to a recess in the bottom housing, the neck portion is clamped between the top housing and the bottom housing, and the stopper and a carrying structure generate an interference along an optical axis of the optical fiber.

22. The optical communication device according to claim 21, wherein the optical fiber comprises a wire core, an outer covering layer, and the protective sleeve, the outer covering layer covers the wire core, the protective sleeve covers the outer covering layer, part of the outer covering layer exposes the optical fiber from the neck portion, the neck portion is an annular recess of the protective sleeve, and the stopper is part of the protective sleeve.

23. The optical communication device according to claim 21, wherein the optical fiber comprises a wire core, an outer covering layer, and a protective sleeve, the outer covering layer covers the wire core, the protective sleeve covers the outer covering layer, and part of the wire core located between the stopper and the base is supported and fixed on a support member.

24. A manufacturing method of an optical communication device, comprising:
providing an optical module, an optical fiber assembly, and a housing, wherein the optical module comprises an optical engine and a circuit board, the optical engine is configured on the circuit board, the optical engine has a photonic integrated circuit, the optical fiber assembly comprises a base, a lid, an optical fiber, and a stopper, the optical fiber passes through the stopper, the optical fiber is clamped between the base and the lid, so that an end of the optical fiber protrudes out of the base and the lid, and the housing comprises a bottom housing and a top housing;
assembling the circuit board and the optical fiber assembly to the bottom housing respectively, wherein the optical fiber assembly is limited by the stopper inserted into a recess of the bottom housing; and
optically coupling the photonic integrated circuit and the optical fiber assembly, comprising:
placing the optical module and the bottom housing on an optical coupling machine;
providing a first adhesive on an adhesive surface of the lid, so that the adhesive surface abuts against the photonic integrated circuit via the first adhesive;
starting the optical engine;
optically coupling the end of the optical fiber to an optical waveguide of the photonic integrated circuit via the optical coupling machine; and
curing the first adhesive; and
assembling the top housing to the bottom housing to cover the optical engine and the optical fiber assembly, so that the optical fiber and the stopper are fixed between the top housing and the bottom housing.

25. The manufacturing method of the optical communication device according to claim 24,
wherein the manufacturing method of the optical fiber assembly comprises:
after the optical fiber passes through the stopper, adhering and fixing the optical fiber and the stopper together via a third adhesive;
placing part of the optical fiber along a groove of the base, so that the end of the optical fiber protrudes out of the groove;
assembling the lid to the base, so that the part of the optical fiber in the groove is clamped between the lid and the base; and
adhering and fixing the lid, the optical fiber, and the base together via a second adhesive.

26. The manufacturing method of the optical communication device according to claim 24,
wherein the first adhesive is an ultraviolet adhesive, and the method of curing the first adhesive comprises:
pre-curing, to temporarily cure the first adhesive by ultraviolet light; and
post-curing, to heat and cure the first adhesive.

27. The manufacturing method of the optical communication device according to claim 24,
wherein the optical coupling machine clamps the lid and the base via a movable clamp to adjust a coupling position of the end of the optical fiber corresponding to the optical waveguide.
